(19) United States
(12) Patent Application Publication
(10) Pub. No.: US 2025/0345855 A1
(43) Pub. Date: Nov. 13, 2025

(54) METHOD FOR DIMENSIONALLY INSPECTING A COMPONENT DURING ADDITIVE MANUFACTURING THEREOF

(71) Applicant: SAFRAN HELICOPTER ENGINES, BORDES (FR)

(72) Inventors: Yann Bernard DANIS, MOISSY CRAMAYEL (FR); Nicolas CARBALLO, MOISSY CRAMAYEL (FR)

(21) Appl. No.: 18/868,855

(22) PCT Filed: May 19, 2023
(86) PCT No.: PCT/FR2023/050722

§ 371 Date: Nov. 25, 2024

(30) Foreign Application Priority Data
May 25, 2022 (FR) FR2205034

(51) Int. Cl. B22F 10/85; B33Y 50/02; G06T 7/00

(52) U.S. Cl. CPC B22F 10/85; B33Y 50/02; G06T 7/001; G06T 2207/10116; G06T 2207/30164

(57) ABSTRACT

A method for dimensionally inspecting at least one component manufactured by an additive manufacturing machine, the additive manufacturing being carried out by successive depositions of a powder bed and by fusing the powder bed after each deposition, the method including acquiring an image of the component being manufactured after at least one procedure of depositing and fusing the powder bed; comparing the image with an image of a reference template; verifying the dimensional conformity of the component on the basis of the comparison.

### TECHNICAL FIELD OF THE INVENTION

The technical field of the invention is that of checking compliance of components manufactured by additive manufacturing.

This invention relates to a method for dimensionally inspecting at least one component manufactured by means of an additive manufacturing machine.

### TECHNOLOGICAL BACKGROUND OF THE INVENTION

Additive manufacturing is a machining technology that has the advantage of enabling manufacture of objects with complex shapes. This technology is, among other things, used in the aerospace industry, for example, to manufacture cooling circuits for gas distributors, air circuits in blades or fuel circuits in a fuel block.

The principle of additive manufacturing is to produce an object by successive additions, also referred to as passes, of one or more materials and to assemble each pass with a preceding pass. Additive manufacturing machines rely on different deposition and assembly technologies. By way of example, some machines make use of the principle of melting and cooling the material, often in powder form, using a laser beam. Other machines may be based on sintering or polymerising of the material.

A drawback of additive manufacturing technologies is that, as a general rule, the components are not accessible during manufacture, for example to carry out inspection in order to check compliance of the manufacture. Indeed, access to the inside of the machine is restricted by the compactness of the machines and also by the overall size of the component or components being manufactured. Furthermore, the atmosphere within an additive manufacturing booth is highly controlled and hermetically sealed for reasons of safety, equipment fragility and to ensure manufacturing quality.

Herein, for a machine based on a powdered metal laser melting technology, the booth atmosphere includes a mixture of gases, sometimes toxic, and volatile residues of the metal powder, which represents a non-negligible health risk for a user, in particular in the event of inhalation. In addition, this type of technology requires the powdered material to be as free as possible of parasitic particles, which is not possible if the booth is not hermetically sealed throughout the manufacturing process. If this were the case, quality of the manufactured components would be severely degraded, and they would become fragile or even non-compliant. Finally, the fragility of equipment such as nozzles and laser of the machine are not compatible with handling during the manufacturing process for inspection purposes. Indeed, the compactness of these machines is such that it would be difficult to carry out inspection without impairing the setting or proper operation of this equipment.

As a result, it is impossible in practice to evaluate compliance and quality of manufacture of the mechanical component being manufactured.

However, there is a real interest in inspecting the quality and integrity of a component when being manufactured. Indeed, although additive manufacturing technologies are well mastered, there are still uncertainties relative to the compliance of final components, in accordance with a specification. As with any manufacturing process, these uncertainties may be inherent in the manufacturing process, in the quality of the powder selected or in hardware or software hazards related to the environment. Being able inspect integrity and quality of the component during manufacture would enable non-compliance to be detected at an early stage, rather than once the component has been fully manufactured. It would then be possible to modify the manufacturing process to prevent the component from becoming non-compliant.

This interest in in-process inspection is all the more pronounced for the manufacture of components with complex internal geometries, especially cavities, as in the case of blades, or recesses. Indeed, these internal geometries are subject to severe geometric restrictions in order to be assembled, in fine, on a suitable machine and to fulfil their function correctly. In the case of blades, these components must comply with maximum overall size restrictions in order to be assembled on an aircraft. In addition, the function of these blades is to circulate a very controlled flow of air to de-ice one or more parts of the aircraft. If the internal geometry of such a blade is not in accordance with the specification, then the air flow risks being impaired too much and the de-icing function of this fluid will not be implemented or will be implemented incorrectly.

Non-destructive volume inspection methods such as ultrasonic imaging, infrared radiography, X-ray radiography, X-ray tomography, thermography, etc. are known from the state of the art. These methods are used to evaluate compliance of components after they have been manufactured by an additive manufacturing machine. However, these methods require dedicated equipment that should be placed close enough to the component to be inspected to reliably evaluate its internal state of health, which is not always compatible with the external geometry of the manufactured component. Furthermore, these conventionally known inspections prove to be unreliable for large material thicknesses, typically greater than 50 mm, or even less if mechanical properties of the material are complex and unfavourable for non-destructive inspection.

Furthermore, some methods are difficult to apply within the scope of mass production of components, since they require large pieces of equipment, which can only evaluate compliance of one component at a time and which are often very expensive. Furthermore, in some cases, the inspection machine cannot inspect the entire component and/or cannot be used to inspect a component whose dimensions exceed some thresholds. One such method is for example infrared tomography.

Destructive inspection methods, such as dissection, are also known. These methods allow the internal compliance of the component to be directly inspected, to the detriment of its future use since the component will be unusable or destroyed. This type of inspection is therefore not contemplatable within the scope of mass production of components using additive manufacturing.

There is therefore a need for a means for inspecting compliance of a component when being manufactured using additive manufacturing technology.

### SUMMARY OF THE INVENTION

The invention aims to remedy drawbacks of the state of the art by providing a method for dimensionally inspecting a mechanical component that can be implemented during the component manufacturing process.

A first aspect of the invention relates to a method for dimensionally inspecting at least one component manufactured by means of an additive manufacturing machine, the additive manufacturing being carried out by successive depositions of a powder bed and by melting the powder bed after each deposition, said method comprising the following steps of:
Acquiring an image of the component being manufactured after at least one step of depositing and melting a powder bed;
Comparing said image with an image of a reference template;
Checking dimensional compliance of the component on the basis of the comparison.

By “dimensional compliance>, it is meant compliance of the internal and/or external geometry of a mechanical component relative to the specification for the manufacture and use of said component.

By virtue of this first aspect, it is possible to evaluate geometric compliance of the component at any time during its manufacture by additive manufacturing, by acquiring images after melting each pass of powder deposited onto the powder bed. This makes it possible to anticipate or detect at an early stage any either internal or external non-dimensional compliance of the component being manufactured.

The advantage of this type of inspection is that it makes it possible, on the one hand, to stop manufacture of the component when its compliance is no longer checked during its manufacture and, on the other hand, if the non-compliance is anticipated, to modify the manufacturing process of the component so as to ensure compliance of the component throughout its manufacture. The method thus makes it possible to reduce the amount of material lost through the manufacture of non-compliant components.

Furthermore, the method is simple to implement and requires little acquisition and processing equipment.

Advantageously, the method is not restricted to additive manufacturing technologies based on melting a powder bed, but can be applied to other types of additive manufacturing technologies.

The method according to a first aspect of the invention may also have one or more of the characteristics hereinafter, taken individually or according to any technically possible combinations.

In one embodiment, the acquisition step is performed by means of a metal oxide semiconductor (CMOS) sensor or charge-coupled device (CCD) sensor camera arranged inside the machine.

By virtue of this embodiment, the method requires minimal, space-saving equipment to implement. Preferably, the camera used is a CMOS camera, since it provides better image contrast than a CCD camera.

In one embodiment, each image acquired includes an internal contour and/or an external contour of the component being manufactured, the internal contour delimiting a perimeter of an internal space of the component in the image and the external contour delimiting an external perimeter of the component in the image.

In one embodiment, the reference template includes at least one set of images of at least one reference component and is obtained after the following steps of:
Acquiring an image after each step of depositing and melting a powder bed upon manufacturing said reference component;
Measuring dimensions of the reference component after it has been manufactured;
Checking compliance of the reference component by comparing the dimensions of the component with the dimensions provided by a specification;
   the template comprising the set of images acquired of the reference component the compliance of which is checked.

By virtue of this embodiment, the reference template used to check dimensional compliance of a component when being manufactured is representative of the manufacture of a compliant component by additive manufacturing. Indeed, this template is obtained from at least one reference component, the compliance of which is checked after manufacture. This compliance is checked in accordance with the specification for the component, which stipulates, among other things, the internal and external dimensions of the final component. Thus, since the compliance of the final component is checked, images acquired throughout its manufacture are representative of the manufacture of a compliant component. The reference template, which contains all these images, is therefore representative of the manufacture of a compliant component by additive manufacturing.

Advantageously, the template makes it possible to take the phenomena of expansion and contraction of the material associated with the melting action of the laser into account. Indeed, the template comprises “hot-acquired” images, i.e. during the manufacture of the reference component, thus when the component is subject to expansion, while the compliance of the reference component is validated “cold”, i.e. once the component has been manufactured, i.e. when the material of the component has contracted. The template therefore provides a robust checking of the component compliance to an additive manufacturing process.

In one embodiment, measuring the dimensions of the reference component after manufacturing the reference component is achieved by X-ray or dissection.

In one embodiment, the reference template is obtained from a plurality of reference components, each reference component the compliance of which with a specification is checked being associated with a set of images acquired of said component, the reference template including the sets of images acquired.

By virtue of this embodiment, the reference template is obtained by a statistical study of the plurality of components. This makes the template more robust for checking compliance of the component during manufacture.

In one embodiment, the reference template is obtained from at least two reference components corresponding to a first and a second set of images acquired respectively, the images acquired of the first set including a minimum internal contour and/or a minimum external contour and the images acquired of the second set including a maximum internal contour and/or a maximum external contour.

By virtue of this embodiment, the method makes it possible to define, in the template, internal and/or external geometric limits of the component contours, in particular relating to an internal cavity, on which dimensional compliance of the component is ascertained. The template is therefore an easy-to-use tool for checking compliance.

In one embodiment, the reference template is obtained from a mean between the contours of the plurality of sets of images for each reference component.

In one embodiment, the reference template includes at least one set of images of at least one reference component, and the method further comprises, after each image acquisition step, a step of superimposing an image of the reference template on the image acquired.

By virtue of this embodiment, checking compliance of the component using the template is quick and easy to implement.

In one embodiment, the method includes a step of stopping manufacture and/or modifying parameters of the additive manufacturing machine, in the event of non-dimensional compliance of the component being manufactured.

By virtue of this embodiment, it is possible to stop manufacture of a non-compliant component, and therefore not to use more material for its manufacture, given that it will be scrapped after manufacture. This also makes it possible to shorten component production times, especially in the case of mass production.

Additionally, this embodiment makes it possible to correct an anticipated non-compliance of the component. Indeed, since the manufacturing history of one or more reference components is known by virtue of all the hot-acquired images, it is possible to detect discrepancy during manufacture relative to this manufacturing history of the reference component. This makes it possible to modify the operation of the additive manufacturing machine on the fly, during manufacture, so as to prevent any non-compliance of the component.

This embodiment therefore makes it possible to reduce the number of non-compliant components manufactured and to reduce the amount of material lost through the manufacture of a component that turns out to be non-compliant.

Another aspect of the invention relates to a computer program product comprising instructions which, when the program is executed on a computer, cause the same to implement the steps of the method according to the invention.

A last aspect of the invention relates to a computer-readable recording medium comprising instructions which, when executed by a computer, cause the same to implement the steps of the method according to the invention.

The invention and its different applications will be better understood upon reading the following description and upon examining the accompanying figures.

### BRIEF DESCRIPTION OF THE FIGURES

The figures are set forth by way of indicating and in no way limiting purposes of the invention.

FIG. 1 illustrates the interior of an additive manufacturing machine.

FIG. 2 is a block diagram illustrating the sequence of steps of a method according to the invention.

FIG. 3 is a representation of the minimum and maximum internal and external contours obtained during one of the steps of the method according to the invention.

### DETAILED DESCRIPTION

Unless otherwise specified, a same element appearing in different figures has a single reference.

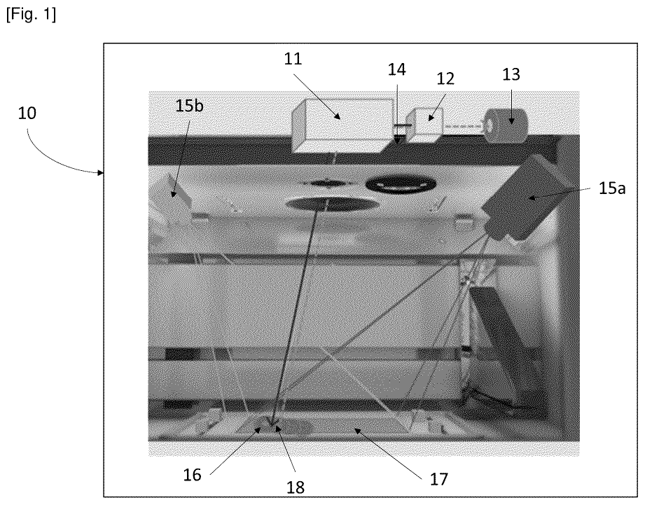

A first aspect of the invention relates to a method for dimensionally inspecting a component manufactured by an additive manufacturing machine, also referred to as a 3D printer. A photograph of the interior of the additive manufacturing machine is provided in FIG. 1.

The additive manufacturing machine 10, also referred to as a 3D printer 10, is based here on the technology of laser melting of a powder bed 16. For this machine 10, the powder bed 16 is formed by successively depositing a controlled amount of powder. After each layer has been deposited, said layer of powder is molten by a laser 14, whose beam is controlled by a dichroic mirror 12 and a photodiode 13, and is oriented by means of a scanner 11. The powder bed 16 is formed on a manufacturing tray 17 adapted to accommodate the powder bed 16. Melting the powder in the powder bed 16 takes place at the location of the laser focal spot 18 on the powder bed 16. The position of the focal spot 18 is controlled by the scanner 11. For example, this is an EOS M290 machine.

Advantageously, the machine 10 comprises an objective lens adapted for image acquisition. The objective lens is, for example, a camera 15 placed in the machine 10 so as to have the entire zone defined by the powder bed 16 in its field of view. Preferably, the camera 15 is positioned in the machine so as not to block propagation of the laser beam from the scanner 11 to the powder bed 16. The camera 15 serves to acquire images of the powder bed where of the component is manufactured, layer after layer.

Preferably, camera 15 is a CMOS (Complementary Metal Oxide Semiconductor) type camera 15a. Alternatively, camera 15 is a Charge-Coupled Device (CCD) camera (15b). The advantage of using a CMOS camera 15a rather than a CCD camera 15b is that the CMOS camera 15a produces images with higher contrast. This is advantageous for the method according to the invention which is, as described below, based on the detection of a difference in contrast in the image acquired by camera 15. The images acquired by the camera 15 may be images in the infrared spectrum and/or images in the visible spectrum.

It is to be noted that the position of the CMOS 15a and CCD 15b cameras in FIG. 1 is purely illustrative and in no way represents a limiting implementation of these cameras in the machine 10. Moreover, only one of these cameras 15 is sufficient for implementing the method according to the invention. The presence in the figure of the two, CMOS 15a and CCD 15b, cameras is again purely for illustrative purposes.

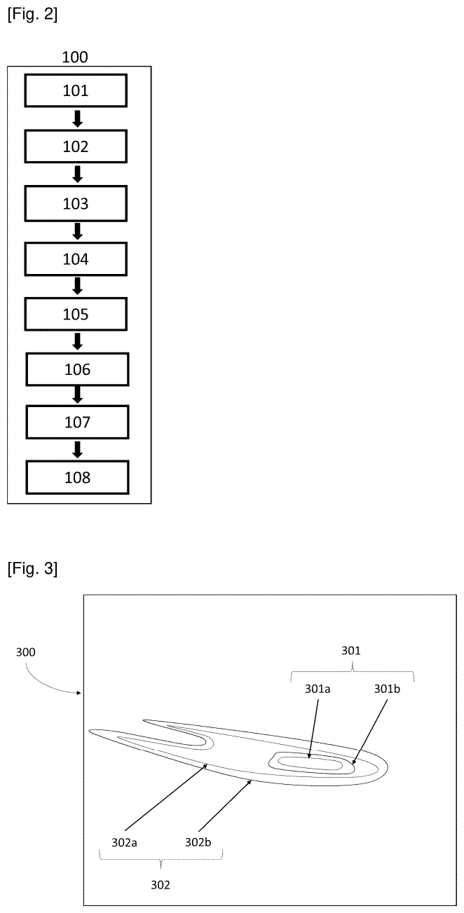

The method according to the invention is illustrated in FIG. 2. Method 100 comprises eight successive steps numbered 101 to 108.

Step 101 is a step of acquiring a set of images of a reference component when being manufactured by machine 10. Preferably, acquiring an image of the reference component being manufactured is performed after the laser 14 has molten each layer of powder deposited onto the powder bed 16.

These images are thus referred to as “hot” images because they are obtained just after the powder has been molten by laser 14. At this point, the material is subject to a strong temperature gradient, since the room temperature in the machine is between 5° C. and 100° C., while the melting temperature of the powder, in the case of a metal powder, is between 1500° C. and 2500° C. This strong thermal gradient therefore induces shrinkage effects on the molten material, with expansion of the material as the powder melts, then contraction as it cools. Additionally, there is also a phenomenon of annealing of the material, since melting a layer may involve remelting the previously molten layer(s) of powder, which is (are) directly below the newly molten layer of powder.

The advantage of acquiring hot images is therefore to be able to take thermal expansion imposed on the material throughout the manufacture of the component, herein the reference component, into account.

For this application example, it is considered that the manufactured component is a blade, designed by means of computer-aided design software from a specification dedicated to said blade, and which includes an internal cavity serving for an air flow to pass therethrough. The advantage of acquiring images throughout the manufacture of the blade is therefore to be able to observe formation of the internal cavity layer by layer.

Preferably, the reference component is designed so that the internal cavity has the smallest dimensions permitted by the specification. For example, the component is designed so that the perimeter of its internal cavity, or other characteristic dimensions of this cavity, is equal to the minimum perimeter tolerated for the cavity by the specification.

Step 102 is then a step of measuring dimensions of said reference component after it has been manufactured.

By “dimensions”, it is meant geometric quantities whose values are imposed by the specification. For example, in the case of the blade, the internal dimensions of the cavity, such as its length, width, height and perimeter, are measured.

Optionally, the external dimensions of the blade, such as the length, width, height and external perimeter of the component, are measured.

These measurements can be carried out by means of a non-destructive inspection technique, for example by infrared or X-ray imaging, or by means of destructive inspection, for example by dissecting the component.

The aim of this step 102 of measuring dimensions of the component is to evaluate dimensions of the reference component after manufacture. “Cold” measurements, i.e. after manufacturing and cooling the reference component, are therefore herein considered.

Step 103 is then a step of checking compliance of the reference component. Compliance of the reference component is evaluated by comparing the cold-measured dimensions of the reference component with the dimensions imposed by the specification.

In this checking step 103, the reference component is defined as being compliant if the cold-measured dimensions are in accordance with the dimensions specified in the specification. For example, a dimension is specified if it is less than or greater than a predefined threshold, or if it lies within a predefined tolerance interval.

Herein, the reference blade is defined as compliant if its internal cavity dimensions are in accordance with the cavity dimensions imposed by the specification.

Step 104 is then a step of determining a reference template from said compliant reference component.

In particular, the reference template is formed from images of the reference component acquired during manufacture of said component. In other words, the template is formed from hot images of the reference component. Preferably, the template comprises all the images acquired of the reference component when being manufactured.

Optionally, the template is determined by applying a contour detection operation to each image acquired, i.e. an operation that automatically detects the contours of a shape in an image, for example by contrast difference. The contour detection operation therefore makes it possible to retain only the contour(s) of the reference component in the image. In particular, contour detection enables the contour of the internal cavity of the reference component to be detected. In other words, each image acquired comprises an internal contour of the component being manufactured, the internal contour delimiting a perimeter of an internal space of the component in the image.

An illustration of these contours is provided in FIG. 3. In this figure, the contours 300 include the internal contour 301, which comprises a minimum internal contour 301a and a maximum internal contour 301b. An external contour 302 is also represented, comprising a minimum external contour 302a and a maximum external contour 302b.

Consequently, the template may comprise only the internal contours 301 detected in each image of the set of hot images of the reference component. The template thus comprises a set of contours 300 delimiting the internal cavity, the dimensions of which are minimal since the reference component has preferably been designed so that the internal cavity dimensions of the blade are the smallest tolerated by the specification. These are referred to as minimum internal contours 301a.

In conclusion, the template comprises, at each moment of manufacture, a minimum internal contour 301a tolerated by the internal cavity for the manufacture of a blade.

Advantageously, the template takes account of thermal expansion of the component during manufacture.

Step 105 is then a step of acquiring one or more images of a new component to be manufactured. It is herein a new blade. The image is acquired by means of camera 15.

The image acquired is therefore a hot image of the new component being manufactured.

Step 106 is then a step of comparing the image acquired with the reference template. The image is preferably acquired after melting one deposited of the powder passes. The pass at which the image is acquired is, for example, the pass associated with a predefined pass number. Alternatively, the pass at which the image is acquired can be selected randomly or on the basis of specific criteria indicating, for example, a pass number at which the image should be acquired.

The comparison is carried out by comparing the image acquired of the new component with the image included in the template which corresponds to the same pass number. Advantageously, this comparison makes it possible to compare the images of two components which have been acquired at the same time during their manufacturing process.

The comparison can be made by superimposing the image of the new component on the corresponding image of the template.

Preferably, in the case where the template comprises the set of minimum internal contours 301a, the image of the new component is compared with the minimum internal contour 301a of the template corresponding to the same pass number.

Step 107 is then a step of checking dimensional compliance of the new manufactured component.

Compliance of the new component is determined on the basis of the comparison carried out in comparison step 106.

Preferably, a component is defined as compliant if the hot image of the new component respects the limitations defined by the minimum internal contour 301a of the template.

Herein, as regards the internal cavity of the blade, compliance of the new component is checked if the internal cavity of the new component in the associated hot image is larger than the minimum internal contour 301a included in the template. In other words, the new component is defined as non-compliant when the minimum internal contour 301a of the template is partially or totally larger than the internal cavity of the new component in the hot image. The internal cavity dimensions of the new component then exceed the reference template.

Lastly, step 108 is a step of stopping manufacture of the new component if the compliance of the component is not checked in step 107 for checking compliance. The advantage of this is that it is possible to prematurely stop manufacture of a component whose non-compliance is detected during its manufacture. This advantageously reduces the amount of powder lost during manufacture of the new non-compliant component. Another advantage is to reduce the time spent manufacturing said new non-compliant component and to trigger, for example, the manufacture of another new component. This is particularly advantageous within the scope of mass production of components.

Stopping manufacturing can be manually performed by an operator and, in this case, step 108 is a step of issuing a non-compliance alert for the new component being manufactured. The alert can then be an audible or visual message indicating that said new component is non-compliant.

Stopping manufacturing can be automatically performed by modifying the control parameters of machine 10. By “control parameters>, it is meant the parameters of machine 10 that enable the manufacture of the component to be controlled. These include, among other things, parameters for controlling the scanner 11, laser 14, dichroic mirror 12 or photodiode 13. In this case, modification of the control parameters to stop manufacture of the new component can be carried out by instructions stored in a memory of a computer controlling the machine 10. The control parameters are therefore modified on the fly during the process of manufacturing the new component.

Method 100 according to the invention is compatible with several alternatives.

According to one alternative, the images of the reference component, hot-acquired in acquisition step 101, also include an external contour 302 of said reference component. In the image, the external contour 302 delimits an external perimeter of the component.

Preferably, the manufactured reference component is designed so that the external perimeter of the component, or other characteristic dimensions of its external geometry, is equal to the maximum perimeter tolerated for the external geometry by the specification.

In this alternative, the reference template, determined in the determination step 104 and comprising the minimum internal contours 301a, also comprises maximum external contours 302b determined in each image of the set of hot-acquired images of the reference component. These maximum external contours 302b are determined by means of the same contour detection operation as for the minimum internal contours 301a. The template therefore comprises, at each moment of manufacture, a maximum tolerated external contour 302b of the reference component. In this case, the template always takes account of the thermal expansion of the component during manufacture.

In step 106 of comparing the hot image acquired for the new component with the reference template, the image is compared with the minimum internal contour 301a and the maximum external contour 302b corresponding to the same pass number.

In step 107 of checking compliance of the new component, compliance of the new component is also evaluated on the basis of the comparison of the hot image of the new component with the maximum external contour 320b. Herein, As regards the external geometry of the blade, compliance of the component is checked if the external geometry of the new component in the associated hot image is smaller than the entire maximum external contour 302b included in the template. In other words, the new component is defined as non-compliant when the maximum external contour 302b of the template is partially or totally smaller than the external geometry of the new component in the hot image. The external dimensions of the component then exceed the reference template.

According to one alternative compatible with the preceding alternative, step 101 of acquiring hot images of the reference component also comprises acquiring hot images of a second reference component.

The second reference component is designed so that the internal cavity has the largest dimensions permitted by the specification. For example, the component is designed so that the perimeter of its internal cavity, or other characteristic dimensions of this cavity, is equal to the maximum perimeter tolerated for the cavity by the specification.

Furthermore, the second reference component can be designed so that the external perimeter of the component, or other characteristic dimensions of its external geometry, is equal to the minimum perimeter tolerated for the external geometry by the specification.

Measurement step 102 also comprises measuring the dimensions of the second reference component, in the same way as for the reference component. In this case, the dimensions of the second reference component are measured cold. For example, in the case of the blade, the internal dimensions of the cavity, such as its length, width, height and perimeter, are measured. Optionally, the external dimensions of the blade, such as the external length, width, height and perimeter of the component, are measured. As with the reference component, these measurements can be made by means of a non-destructive inspection technique, for example by infrared or X-ray imaging, or by means of destructive inspection, for example by dissecting the component.

The step 103 of checking compliance also comprises checking compliance of the second reference component. This compliance is evaluated by comparing the cold-measured dimensions of the second reference component with the dimensions imposed by the specification. The second reference component is defined as being compliant if the cold-measured dimensions are in accordance with the dimensions specified in the specification. For example, a dimension is provided if it is less than or greater than a predefined threshold, or if it lies within a predefined tolerance interval. Herein, the reference blade is defined as being compliant if the dimensions of its internal cavity are in accordance with the dimensions of the cavity imposed by the specification.

The template, determined in template determination step 104, then comprises the set of hot images of the reference component defined as being compliant, as well as the set of hot images of the second reference component defined as being in compliant. Preferably, the template comprises the contours 300 determined by contour detection in the set of hot images of the reference component, and also contours 300 determined by the same operation in the set of hot images of the second reference component. The template therefore also comprises, at each instant of manufacture, a maximum internal contour 301b and a minimum external contour 302a tolerated by the reference component, taken from the set of hot images of the second reference component. Once again, the template takes account of the thermal expansion of the component during manufacture.

Consequently, in step 106 of comparing the hot image of the new component with the reference template, the hot image is compared with the minimum 301a and maximum 301b internal contours, and with the minimum 302a and maximum 302b external contours, corresponding to the same pass number.

Thus, in step 107 of checking compliance of the new component, the compliance of the new component is also evaluated on the basis of the comparison of the image of the new hot component with the maximum internal contour 302b and the minimum external contour 302a.

As regards the internal cavity of the blade, compliance of the new component is checked if the internal cavity of the new component in the associated hot image is larger than the minimum internal contour 301a and smaller than the maximum internal contour 301b, included in the reference template. In other words, the new component is defined as non-compliant when the minimum internal contour 301a of the template is partially or totally larger than the internal cavity of the new component in the hot-acquired image and/or when the maximum internal contour 301b of the template is partially or totally smaller than the internal cavity of the new component in the hot-acquired image. The internal cavity dimensions of the new component then exceed the reference template.

As regards the external geometry of the blade, compliance of the component is checked if the external geometry of the new component in the associated hot image is smaller than the entire maximum external contour 302b and larger than the entire minimum external contour 302a, included in the template. In other words, the new component is defined as non-compliant when the maximum external contour 302b of the template is partially or totally smaller than the external geometry of the new component in the hot image and/or when the minimum external contour 302a of the template is partially or totally larger than the external geometry of the new component in the hot-acquired image. The external dimensions of the new component then exceed the reference template.

According to an alternative compatible with the preceding alternative, the hot image acquisition step 101 comprises acquiring hot images for a plurality of reference components. Namely, a hot image is acquired for each reference component after melting each pass of deposited powder. An image may, optionally, be an image of several of the plurality of reference components or be an image of all of the plurality of reference components. The advantage of using several reference components is to have a varied range of reference components and a set of associated hot images.

These reference components can be designed so that their internal and external dimensions, i.e. the internal cavity dimensions and the external geometry of the blade, meet the dimensional requirements of the component as described in the specification.

Steps of measuring 102 and checking 103 compliance are therefore implemented for each of the components in the plurality of reference components.

Thus, the template determined in step 104 can be determined on the basis of the checked compliance of the reference components of the plurality of reference components. In this case, it is possible to determine which of the compliant reference components have extreme internal and external dimensions. It is then possible to determine:
a reference component, among the plurality of reference components, whose internal cavity dimensions are the smallest;
a reference component, among the plurality of reference components, whose internal cavity dimensions are the largest;
a reference component, among the plurality of reference components, whose external geometry dimensions are the smallest;
a reference component, from among the plurality of reference components, whose external geometry dimensions are the largest.

Optionally, the same reference component can have extreme internal cavity dimensions and extreme external geometry dimensions. The template can therefore be determined from sets of images of two, three or four different reference components with extreme dimensions.

Advantageously, the template can be determined from contours obtained 300 by the contour detection operation previously mentioned. In this case, contour detection can be applied to each of the images of the two, three or four sets of images of the reference components whose dimensions are extreme. The advantage is to determine:
the minimum internal contour 301a of each hot image associated with the reference component, whose internal cavity dimensions are minimal;
the maximum internal contour 301b of each hot image associated with the reference component whose internal cavity dimensions are maximal;
the minimum external contour 302a of each hot image associated with the reference component, whose external geometry dimensions are minimal;
the maximum external contour 302b of each hot image associated with the reference component whose external geometry dimensions are maximal.

This contour determination operation makes it possible to determine sets of minimum 301a and maximum 301b internal contours and minimum 302a and maximum 302b external contours.

The template then comprises the sets of minimum 301a and maximum 301b internal contours and minimum 302a and maximum 302b external contours derived from the hot images of the sets of images of the reference components of extreme dimensions.

According to one alternative compatible with the preceding alternative, it is possible to determine:
at least two reference components, among the plurality of reference components, whose internal cavity dimensions are the smallest;
at least two reference components, among the plurality of reference components, whose internal cavity dimensions are the largest;
at least two reference components, among the plurality of reference components, whose external geometry dimensions are the smallest;
at least two reference components, from the plurality of reference components, whose external geometry dimensions are the largest.

The advantage is to have, for each end, at least two reference components and to average the contours 300 determined from the hot images of these reference components.

These at least two components can be determined on the basis of an interval or threshold for the extreme internal and external dimensions. That is, it is possible to consider that a reference component has extreme internal and/or external dimensions if these dimensions are greater than or less than one or more predefined extreme thresholds for each dimension, or if these dimensions are within one or more predefined extreme intervals. These predefined extreme thresholds and/or predefined extreme intervals can be defined on the basis of specification requirements.

Once the reference components including the extreme dimensions have been determined, it is possible to determine the contour(s) 300 for each hot image of each set of images of each reference component with extreme dimensions such that the following is achieved:
the minimum internal contour 301a of each hot image associated with reference components whose internal cavity dimensions are minimal;
the maximum internal contour 301b of each hot image associated with the reference components whose internal cavity dimensions are maximal;
the minimum external contour 302a of each hot image associated with the reference components, whose external geometry dimensions are minimal;
the maximum external contour 302b of each hot image associated with the reference components whose external geometry dimensions are maximal.

In this case, it is possible to average the contours 300 of the same type obtained for the images acquired at the same moment in the manufacturing process. In other words, after melting a given pass, the minimum 301a and maximum 301b internal contours determined in the hot images associated with said pass are respectively averaged together. The minimum 302a and maximum 302b external contours determined in the hot images associated with said pass are also respectively averaged together. The reference template is then an averaged reference template comprising the averaged extreme contours of the internal cavity and the external geometry of a plurality of reference components whose dimensions are extreme.

According to one alternative compatible with the preceding alternatives, the acquisition step 105 comprises acquiring a plurality of hot images of the new component being manufactured. This plurality of images acquired can then be compared with the reference template, in the same way as in the case of a single image, by ensuring that the hot images of the new component are compared with the hot images or contours 300 associated with the same manufacturing time, i.e. the same pass number. It is then possible to monitor the new manufactured component throughout its manufacture and to detect the occurrence of any non-compliance during manufacture.

According to one alternative compatible with the preceding alternatives, steps 105 to 108 according to the method 100 can be implemented for a plurality of new components. The advantage is, within the scope of mass production of new components, to speed up the time required for inspection and manufacture and to optimise the number of components manufactured per batch.

In such an alternative, the image acquired in step 105 may be an image of all the new components of the plurality of new components. Optionally, it is possible to acquire, after melting each pass, several hot images, each hot image being an image of at least one of the new components of the plurality of new components. Preferably, each new component is imaged by a single image in order to avoid redundancy.

Thus, the comparison at step 106 and the compliance check at step 107 are carried out for each new component for the plurality of new components in order to determine one or more new components whose compliance is not checked.

Furthermore, in manufacture stopping step 108, only the manufacture of the new non-compliant component or components is stopped and the components whose compliance has been checked continue to be manufactured. In this case, the operator manually modifies the machine control parameters so as to stop manufacture of said new non-compliant components, for example after issuing an audible or visual non-compliance alert comprising an identification of said components; or alternatively, instructions included in the memory of the control computer are adapted to automatically modify the control parameters and stop the manufacture of said new non-compliant components.

Each set of hot images or contours 300 included in the template can be assimilated to a manufacturing history of the reference component with which it is associated. Thus, this history can be used to predict the future growth of a component being manufactured by virtue of comparing the hot images of the new component with the template. Herein, it is possible to determine a discrepancy in the growth of the component, through successive additions of material, by virtue of this comparison. Thus it is possible to determine whether a component deviates from a known growth pattern and is likely to lead to non-compliance.

Consequently, step 108 may be a step of modifying parameters for controlling the additive manufacturing machine 10.

Step 108 can initially detect a deviation in the growth of the new component. The deviation is, for example, detected on the basis of a discrepancy relative to the growth history, of one or more reference components, contained in the template. The discrepancy can be quantified by a difference or degree of resemblance, for example by means of a correlation, between one or more hot images or contours 300 of the reference template and the hot image of the new component. In the event that the discrepancy is significant, for example when the discrepancy is greater than some threshold defined by specific requirements or an analysis of manufacturing histories of reference components, then an action to modify the parameters controlling the machine 10 for manufacturing the component is triggered.

The parameters controlling the machine 10 are then modified so as to avoid the new component becoming non-compliant during its manufacture, for example by compensating for the significant deviation detected. Modifying the control parameters is therefore performed on the fly during the manufacturing process of the new component. Modifying the control parameters can be performed automatically using instructions stored in the memory of the machine 10 control computer. Alternatively, the modification can be carried out manually by an operator and, in this case, step 108 is a step of issuing an alert containing information about the significant deviation of a new component and information for identifying said new component, especially if several components are manufactured at the same time. Advantageously, modifying the control parameters does not affect the manufacture of any other new components manufactured in parallel with the new component in machine 10.

Furthermore, the significant deviation can be detected on the basis of the history of non-compliant reference components. Thus, it is possible to detect that the growth of a new component, during its manufacture, significantly deviates when its growth becomes close or similar to the growth in the history of a non-compliant reference component. The proximity or similarity of growth can again be evaluated by a discrepancy between the growth of the new component and the history of one or more non-compliant components. The discrepancy can, by way of example, be quantified by a difference or degree of resemblance, for example by means of a correlation, between one or more hot images or contours 300 of the reference template and the hot image of the new component. The deviation is significant, for example, when the proximity or similarity is greater than some threshold defined by specific requirements or an analysis of the manufacturing history of reference components.

Furthermore, it is possible to use the hot image histories of new components already manufactured whose compliance has been evaluated in order to predict the compliance of another new component being manufactured. The prediction is then implemented in the same way as for compliant and non-compliant reference components, as described in this alternative.

1. A method for dimensionally inspecting at least one component manufactured by an additive manufacturing machine, the additive manufacturing being carried out by successive depositions of a powder bed and by melting the powder bed after each deposition, said method comprising:
acquiring an image of the component being manufactured after at least one step of depositing and melting a powder bed;
comparing said image with an image of a reference template, the reference template being obtained from a reference component corresponding to a first set of images acquired upon manufacturing the reference component, the reference template comprising the first set of images, the images acquired of the first set including a minimum internal contour and/or a minimum external contour, and
checking dimensional compliance of the component on the basis of the comparison.

2. The method according to claim 1, wherein the acquiring is performed by a metal oxide semiconductor sensor or charge coupled device sensor camera arranged inside the machine.

3. The method according to claim 1, wherein each image acquired includes an internal contour and/or an external contour of the component being manufactured, the internal contour delimiting a perimeter of an internal space of the component in the image and the external contour delimiting an external perimeter of the component in the image.

4. The method according to claim 1, wherein the reference template is obtained after the following steps of:
acquiring an image after each step of depositing and melting a powder bed upon manufacturing said reference component;
measuring dimensions of the reference component after manufacturing the reference component;
checking compliance of the reference component by comparing the dimensions of the component with the dimensions provided by a specification;
the reference template comprising the first set of images acquired of the reference component the compliance of which is checked.

5. The method according to claim 4, wherein measuring the dimensions of the reference component after manufacturing the reference component is achieved by X-ray or dissection.

6. The method according to claim 5, wherein the reference template is obtained from a plurality of reference components, each reference component the compliance of which with a specification is checked being associated with a set of images acquired of said component, the reference template including the sets of images acquired.

7. The method according to claim 6, wherein the reference template is obtained from at least two reference components corresponding to the first and to a second set of images acquired respectively, the images acquired of the first set including the minimum internal contour and/or the minimum external contour and the images acquired of the second set including a maximum internal contour and/or a maximum external contour.

8. The method according to claim 6, wherein the reference template is obtained from a mean between the contours of the plurality of sets of images for each reference component.

9. The method according to claim 1, wherein the reference template includes at least one set of images of at least one reference component, the method further comprising, after each image acquisition step, a step of superimposing an image of the reference template on the image acquired.

10. The method according to claim 1, comprising stopping manufacture and/or modifying parameters of the additive manufacturing machine, in the event of non-dimensional compliance of the component being manufactured.
